(19) United States
(12) Patent Application Publication
(10) Pub. No.: US 2002/0073170 A1
(43) Pub. Date: Jun. 13, 2002

(54) Method and apparatus for mobile wireless communication

(75) Inventors: Henry P. Hoffman, Joplin, MO (US); David N. Mendez, Overland Park, KS (US); Kory S. Dillman, Independence, MO (US)

Correspondence Address: FITCH EVEN TABIN AND FLANNERY, 120 SOUTH LA SALLE STREET, SUITE 1600, CHICAGO, IL, 60603-3406, US

(73) Assignee: SiriCOMM, Inc.

(21) Appl. No.: 09/836,989

(22) Filed: Apr. 18, 2001

Related U.S. Application Data
(60) Provisional application No. 60/198,177, filed on Apr. 19, 2000.

(51) Int. Cl. G06F 15/16

(52) U.S. Cl. 709/217

(57) ABSTRACT

An apparatus and method have a hub server for storing a relational database of information relating to trucking operations. The hub server is connected via a satellite link to an earth satellite which is connected through downlinks and uplinks to localize truck stop servers (TSS). The TSS in turn communicate via spread spectrum radio frequency signals with hand-held computers, such as personal digital assistants. The PDAs are used by truck drivers to send and receive e-mails and other information such as electronic freight bills, fuel information, route information and the like from the trucking company and to transmit information to the trucking company. In addition, a trucking company server may be accessed through the Internet by customer servers or third party servers to identify aspects of the trucking shipment.

### CROSS-REFERENCE TO RELATED APPLICATION

Priority is claimed from U.S. provisional application No. 60/198,177, filed Apr. 19, 2000.

### BACKGROUND OF THE INVENTION

The invention generally relates to a mobile wireless communication system. In particular the invention relates to a satellite-based mobile wireless communication system having a relational database and to a method and apparatus for maintaining the database current in the face of interruptions in communication.

Freight carrying operations, and in particular, trucking operations in today's environment are growing increasingly expensive to use and thus are forcing on the trucking companies increasingly efficient methods of operation. Some trucking companies are now using global positioning systems attached to their trucks including transponders or antennas, which will enable the trucking companyies to determine the location of the trucks.

Other companies have attempted to automate at least part of the paper handling associated with the trucking company, for instance. It is known that company's such as United Parcel Service have large easel-type computer systems for entry of signatures thereon and verification that products have been received. In addition, trucking and freight forwarding companies often rely on the use of bar codes to track shipments through client server networks in order to determine the location of goods and services.

Oftentimes, however, even with these added features, it is difficult to handle the flow of information efficiently for shipping operations. For instance, it may turn out that a truck driver is to pick up twelve pallets of a particular freight shipment from a company. A driver arrives at the company and is told that he is only to pick up ten pallets. He makes a separate notation because the freight bill should not be changed indicating that he has received less than the full load, and that hand written notation must later be reconciled through a number of steps between the trucking company, or shipper and the company whose product is being shipped. This is time consuming and wasteful.

Another problem that trucking companies are currently faced with is the recruiting of drivers when there is a high competition for drivers. It is often almost impossible to recruit drivers reliably as by the time employment application form is filled out, and transmitted through the trucking company's internal business systems, the driver may have been hired by a competing company.

In addition, while some wireless communication systems have been provided to trucks, the communications are geographically spotty and in some cases also run at relatively low data rates limiting the amount of data that can be sent to the truck or received from the truck and the flexibility of the system. In addition, the system often requires that a driver may have to physically plug a link into a wall socket or the like to obtain access to a telephone system or network which would necessitate stopping the truck, parking the truck for a certain limited period of time in order to transfer the data.

Thus, what is needed is a wide area coverage system with rapid information updating and convenient linking to a truck driver so that the information may be transmitted as near as possible as real time fashion from the driver to the trucking company and from the trucking company back to the driver.

### SUMMARY OF THE INVENTION

A method and apparatus embodying the present invention comprised of a hub server for storing trucking and shipping information such as electronic freight bills, driver employment forms, and the like in electronic format. The hub server stores the information in relational database that is updated periodically via communications through a satellite ground station. The satellite ground station communicates with an earth satellite which communicates with multiple ground stations at various locations connected to truck stop servers which function as proxy servers. Each of the truck stop servers has associated with it a spread spectrum communication system which can communicate via spread spectrum through wireless modems connected to personal digital assistance or laptop computers being used by truck drivers. In addition, the hub server may be connected to customer servers and to third party servers to exchange information regarding shipments with them.

The system embodying the present invention includes system level applications including the ability to detect network access, a PDA-based web browser and an e-mail client which may communicate over the system assets. Routines also execute processes,. for instance, sending and receiving e-mail, executing database modifications and queries, executing queued applications and the like. This provides a drive-by feature which will enable truck drivers and others to communicate with the network without the necessity of stopping at a wireless local area network location. In addition, the system includes a web browser which is compatible with standard personal digital assistants and standard TCP/IP HTTP/HTML browsers. The browser is capable of caching web pages for offline viewing and allows real-time access to online forms. The browser supports cookies and and SSL technologies by using a proxy server that resides on a node server.

A PDA-compatible e-mail client also functions on the network. Specific features of the client will include the ability to download email from truck stop server mail servers allowing POP/SMTP access. The ability to link to address books and an option to download email headers only for compact display. In addition, leave message-on-server activities are supported.

More specifically, trucking companies can send pay settlements and pay stubs to drivers over the network in order to provide timely detailed descriptions of the drivers pay. This will reduce operating costs through the elimination of long distance calls to trucking company payroll departments. The system may be integrated with trucking company application servers, typically IBM AS-400 computers in order to automatically generate formatted email pay settlements.

An authorized fuel network application enables trucking companies to inform drivers in real time over the network of fuel network changes including changes in fuel pricing. Drivers are able to receive directions over the network to fuel stops as well as listing of amenities thereat. This enables trucking companies to save significant amounts of money by utilizing appropriate fuel stops with low prices and receiving the most current and lowest pricing available. The fuel network application is managed and updated through-a web browser interface as necessary by trucking company fuel managers.

Truck maintenance tracking is also available. Maintenance information is entered and transmitted wirelessly to a fleet maintenance department of the trucking company over the network for recording. The driver or company receives notification through a PDA or through a hub server of upcoming scheduled maintenance. The database has regularly performed maintenance and time or mileage intervals available. The database may be customized by individual trucking companies to enter their own maintenance schedules.

Local condition reporting may be performed over email. A driver uses his PDA to send email to a maintenance facility warning that there is a problem that needs attention. This enables a maintenance bay to be reserved before the driver arrives at the facility, thereby saving time.

Part of the database information to be made available from the hub server will be indications of freight which is to be hauled. The users have the ability to enter specific search criteria including starting location, destination, trailer type, availability, time and date. Once entered, the search criteria are compared to third party load databases through the hub returning matching loads, as indicated through the PDA. The driver may then have discretion selecting a load.

Electronic freight bills will be prepared by the system and will enable drivers to electronically exchange freight bills with the trucking company, shippers and consignees. Electronic freight bills complete a logistic chain by providing both in-transent visibility and data integrity throughout a shipping cycle..

Electronic employment applications are also handled by the network and may be completed by driver applicants on hand-held computers such as PDA's or laptops. The application is in a wizard format and captures the applicant's signature. Once complete, the recruit's application and signature are sent electronically over the network to the trucking company's recruiting office for rapid processing. Individual trucking companies may customize at least a portion of the employment application and input the recipient's email address, track sender information, and integrate it into existing services.

Electronic driver logs are handled by the system, wherein drivers through their PDA's will enter time and activity, including driving, sleeper berth, off duty or on duty, not driving. The software will verify that all hours are legal. After entry of the information in the PDA or laptop, a graphic similar to paper logs will be displayed on the PDA or laptop computer. The log book entry will then be delivered electronically to the trucking company over the network for recording in the trucking company databases. The log entries will include the date, including month, day and year, the vehicle number, driver I.D., the miles driven that day, the name of the carrier or carriers, the main office address, the home terminal address, name of co-driver, if any. Including, in addition, the hourly entries will have descriptions associated with them including city, state, shipping yard activity, loading, unloading, fueling and the like.

In order to carry out all of the above tasks, a database replication system is provided by the apparatus and method embodying the instant invention. For scheduling large bursts of data so that when satellite connections are created an efficient use of network resources can be obtained. Between the bursts of data, all data remains available at all access points on the network. Race conditions are eliminated by conflict resolution logic built into the server and client side applications.

A central controlling server or hub functions as a master synchronizing system for all external access points or truck stop stations (TSS). If a change occurs in the database located in the hub, the change is broadcast to all the TSS. If a change occurs in the database located on one of the truck stop servers, then that change is sent back to the hub and then broadcast to all of the stations. All broadcasts are sequenced in a manner similar to that done for transmission control protocol packets for error correction so that the broadcast provides a reliable transport method for all systems. A satellite network compatible with television signals allows six megabit per second bursts to all stations on the hub. TSS stations communicate back to the hub using a 6K per second data rate. The data moving from a TSS back to the hub is relatively small compared to the outbound data from the hub. By design the network only allows forty connections to be created from TSS stations to the hub. This has the benefit that it will guarantee that the hub will not be overrun by communication requests from the TSS station.

The satellite communication is run over a Cislunar Networks system using compression technology that allows data to be efficiently transmitted at low cost. Each of the wireless local area network (WLAN) sites is comprised of a proxy server or TSS and wireless access points. The server enables local storage and rapid access to very large amounts of data. This combination of truck stop server and wireless access points enables information to be accessible by network subscribers from within their vehicles, local restaurants, and the like without being required to send and receive information over land lying communications. The wireless LAN network implements IEEE 802.11b wireless technology using spread spectrum technology.

This communicates wirelessly to PDAs which, in the present embodiment, are Palm-OS units or devices which are compatible therewith. In the alternative, a Symbol 1740 wireless Palm OS computer may be used. In order to provide security the software performs 128 bit encryption on data being transferred between servers. Encryption is based on 64 wired equivalence privacy standards and uses a 40 bit secret key plus 24 bit initialization vectors.

It is an aspect of the present invention to provide a complete end-to-end wireless communication system for use in the trucking industry to allow truck drivers to quickly and effortlessly communicate trucking related information as well as personal information via email and web browser with a hub server which may be connected to a variety of trucking company servers and third party servers.

It is another aspect of the present invention to provide communication which is wireless and need not be linked to ground-based systems.

It is a still further aspect of the present invention to provide a wireless trucking information communication system which provides rapid and accurately real-time data updating over satellite communications.

Other aspects of the invention will become obvious to one of ordinary skill in the art upon a perusal of the following specification and claims in light of the accompanying drawings.

### BRIEF DESCRIPTION OF THE DRAWINGS

FIG. 1 is a block of an apparatus embodying the present invention;

FIG. 2 is a block diagram showing the relationship between the hub server and a customer network and the internet;

FIG. 3 is a block diagram of a link between a hub server and a satellite system to a truck stop server and network connections to wireless access points;

FIG. 4 is a block diagram of the connection from a satellite receiver to truck stop servers and personal digital assistants and laptops;

FIG. 5 is a block diagram of the contents of a synchronization packet;

FIG. 6 is a flow chart showing details of information provided for electronic driver load indications;

FIGS. 7A and 7B are a table of the types of descriptions of equipment which is stored in the database and handled by the PDAs;

FIG. 8 is a flow chart of the manner in which an electronic log is kept;

FIG. 9 is a flow chart of the handling of an electronic flat belt;

FIG. 10 is a flow chart showing steps of incoming data management for a hub;

FIG. 11 is a flow chart showing steps of outgoing data management for a hub;

FIG. 12 is a flow chart showing steps of incoming data management for a truck stop server;

FIG. 13 is a flow chart showing steps of outgoing data management for a truck stop server;

FIG. 14 A and 14 B are renderings of screens for the preparation of electronic freight bills; and

FIG. 15 is a rendering of the driver application screens presented on a personal digital assistant or laptop computer for transfer of data via truck stop server to a hub.

### DETAILED DESCRIPTION OF THE PREFERRED EMBODIMENTS

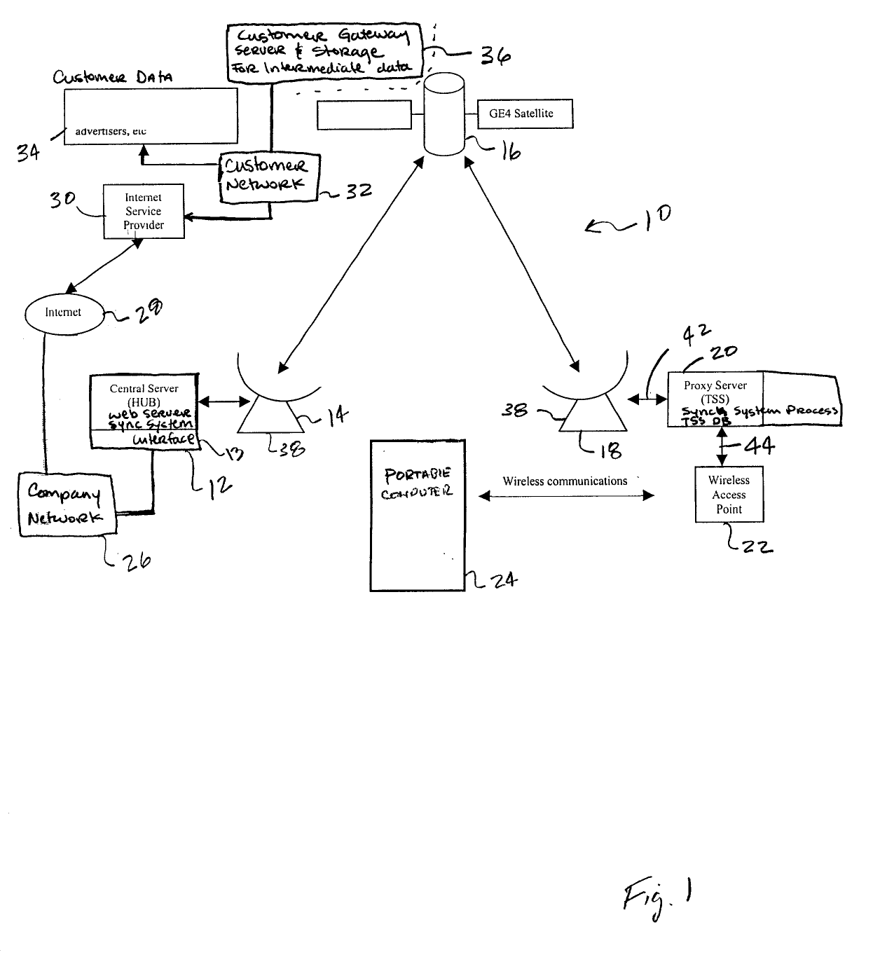

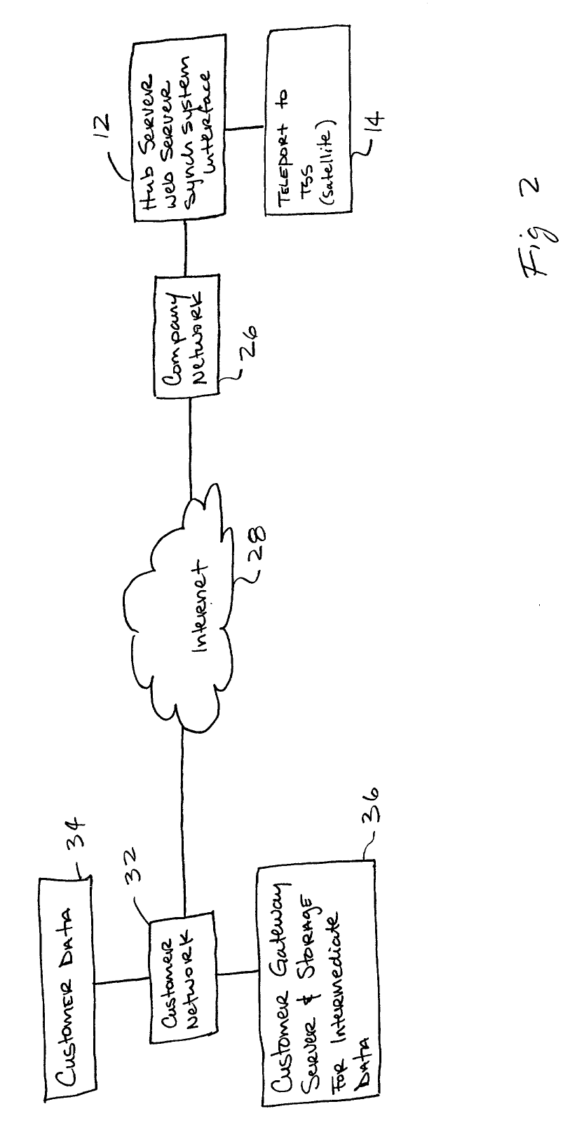

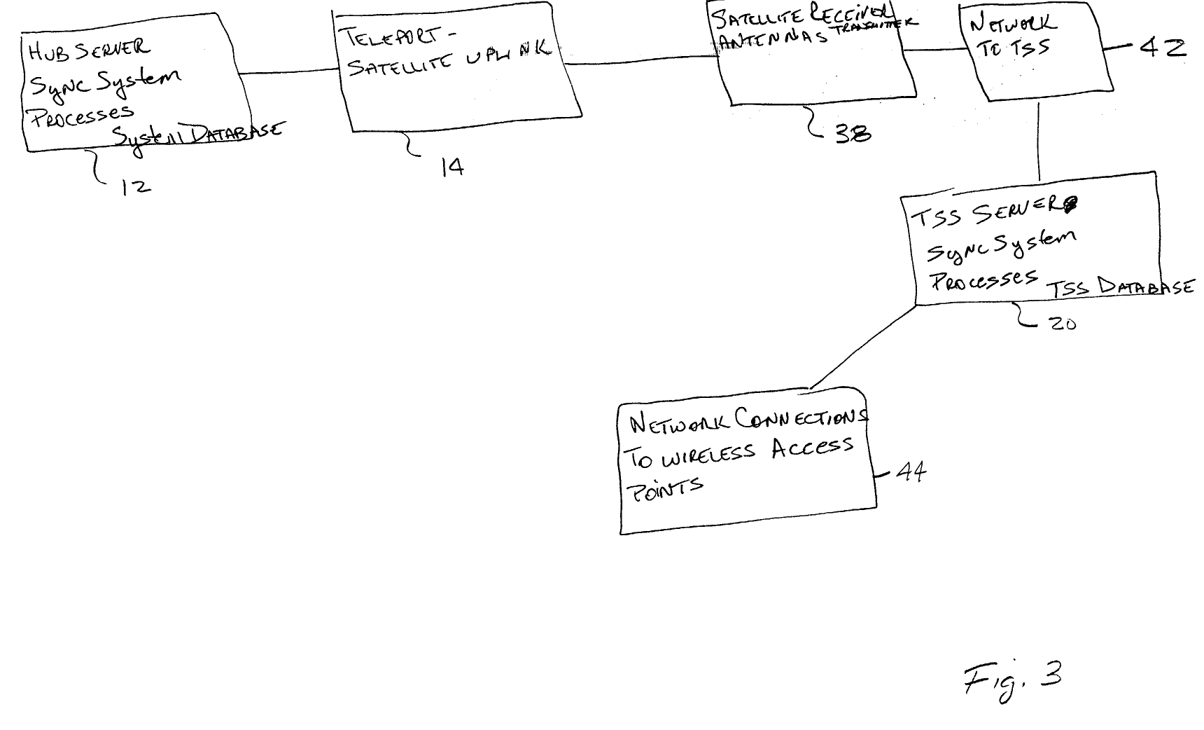

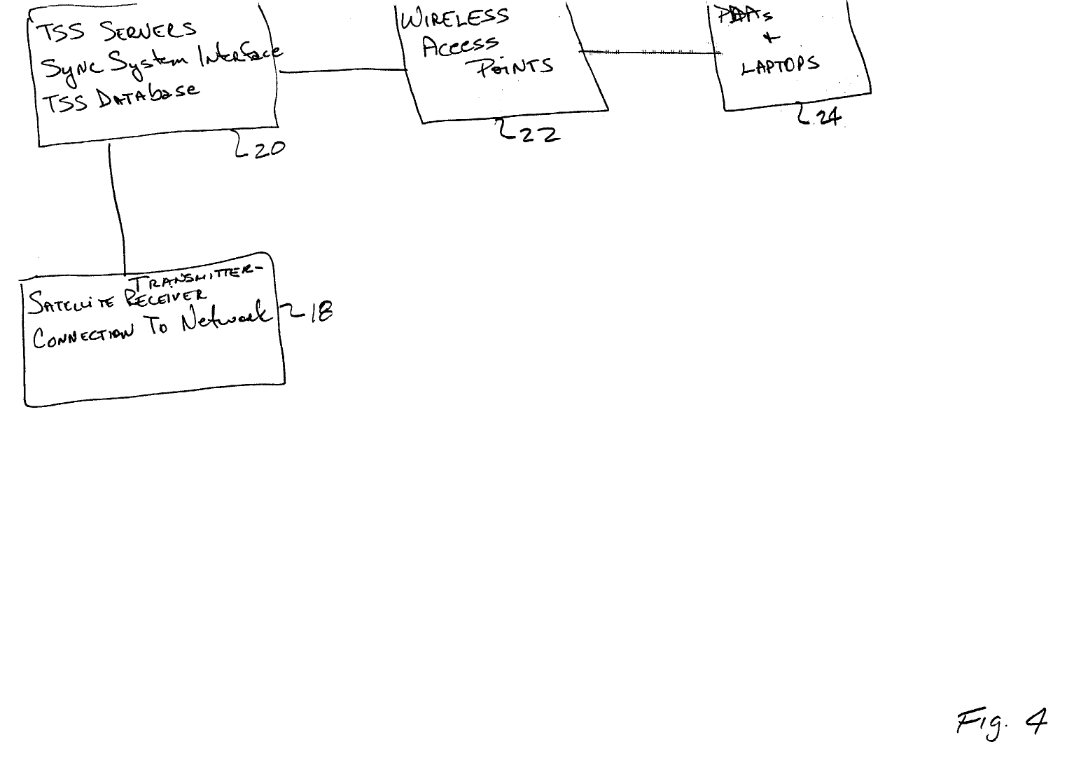

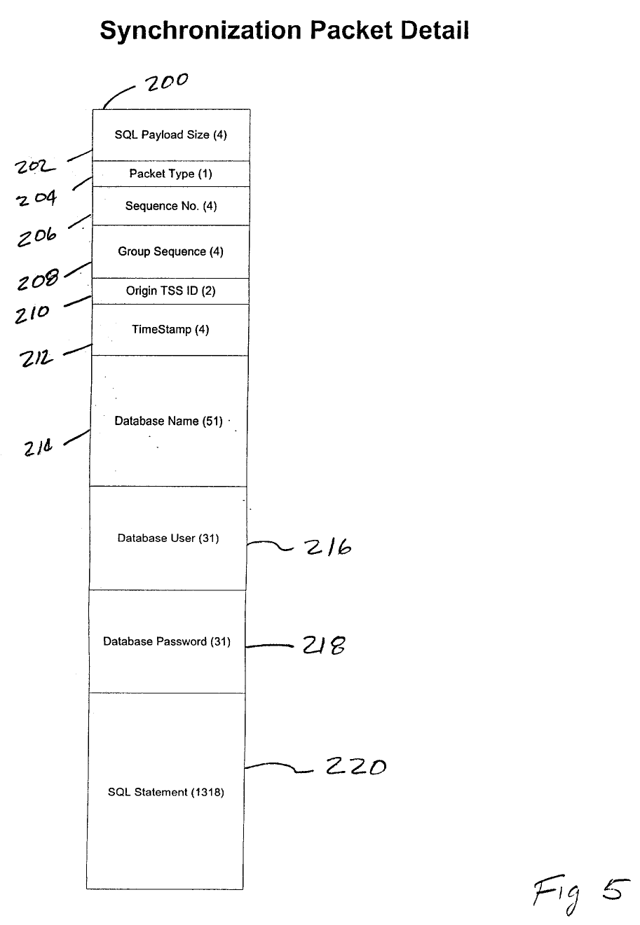

Referring now to the drawings, and especially to FIG. 1, an apparatus that is generally referred to by reference numeral 10 and embodying the present invention is shown therein. The central hub server 12 which includes a web server having a data synchronization system, a database and an interface 13 is connected to a satellite teleport 14 which is able to communicate with an earth satellite 16 with a type which carries television transmissions. In this case it is a GE4 satellite. The satellite also sends signals to a satellite teleport 18 which is a ground-based station connected over a link to a local node server or proxy server or truck stop server (TSS) 20 which also includes system synchronization process software as well as a TSS database. Multiple TSSs are connected to the system at various truck stops. The proxy server can communicate a portion of its database information to a wireless access point which is a spread spectrum transceiver system communicating using IEEE802.11b protocols with a hand held computer 24 which may comprise a palmal S device, a Windows CE device, etc. including a wireless modem therein which is compatible with 802.11. In addition, information from the hub server may be shared with a company network 26 which may communicate via the Internet 28 to company customers through an Internet service provider 30 which is coupled to a customer network 32. The customer network 32 includes customer data 34 which may be related to trucking company data, advertising data, etc. The customer network has connected to it a customer gateway server and storage for intermediate data for manipulation in other instances.

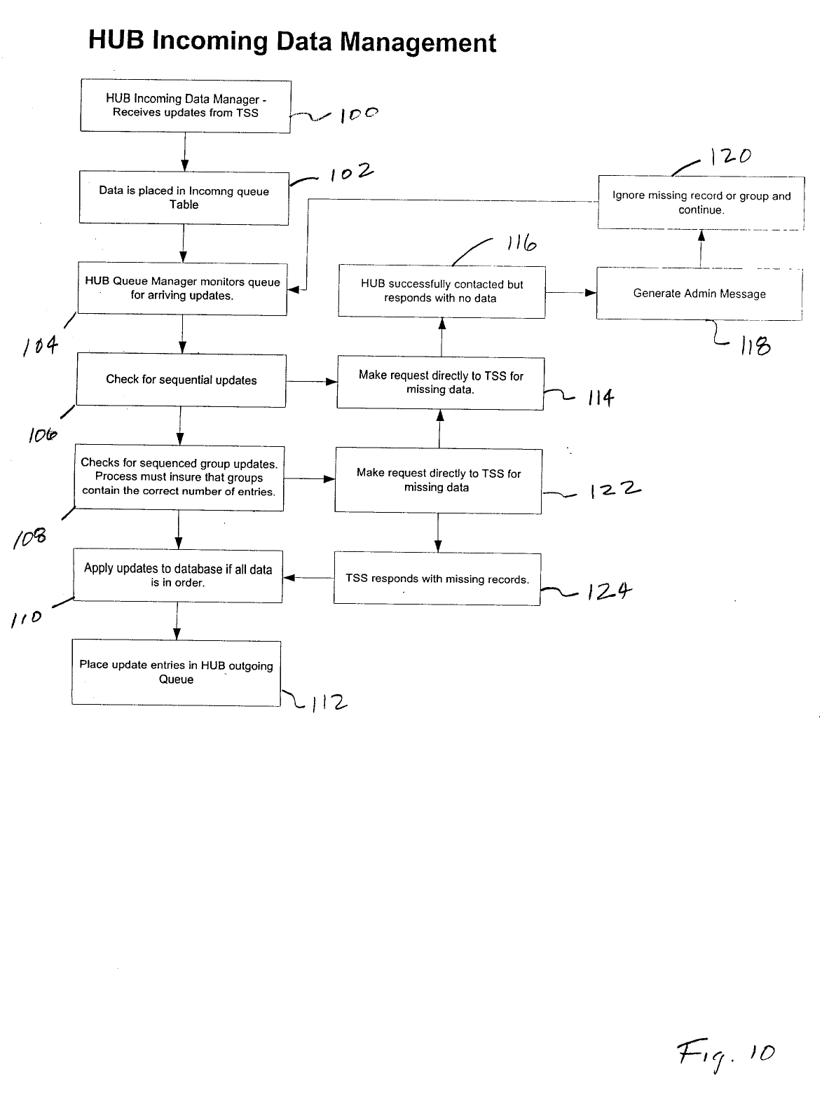

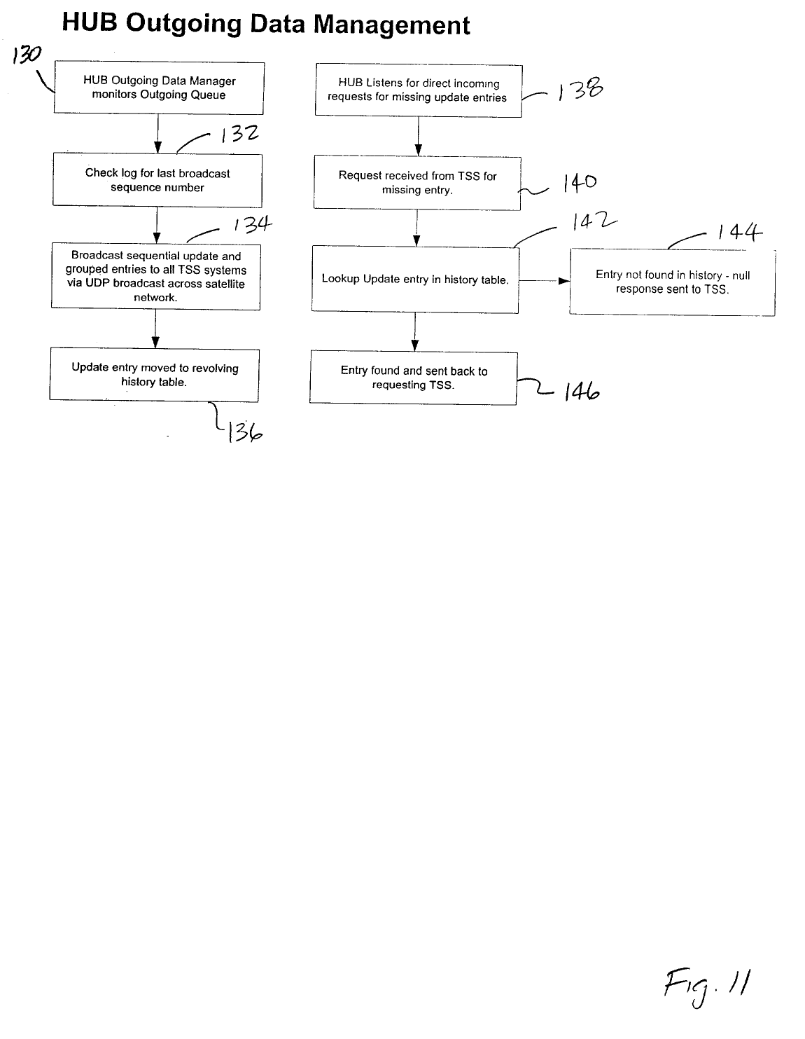

Referring now to FIG. 9 an incoming data management flow for the hub is shown therein, including a step 100, which the hub incoming data manager receives updates over the satellite network from a truck stop server. In a step 102 the data is placed in an incoming cubed table. In a step 104 the hub cube manager monitors the queue for arriving updates and checks for sequential updates in a step 106. In a step 108 the system checks for sequenced group updates in order to ensure the groups contain the correct number of entries which are expected. In a step 110, the updates are applied to the database assuming that the sequence group updates and the sequential updates were in order. In a step 112, the update entries are placed in a hub outgoing queue. In the event that the sequential update check is not passed in step 106, a request is made in a step 114 directly to the TSS for missing data. The hub is-then contacted but responds with no data in a step 116 and generates an administrative message in a step 118. In a step 120 the missing record or group is ignored and the process continues. In the event that the sequence group update check of step 108 fails, the request is made to the TSS for the missing data, which is similar to the step 114 in a step 122. The TSS responds with the missing records in a step 124, and transfers control back to the step 110.

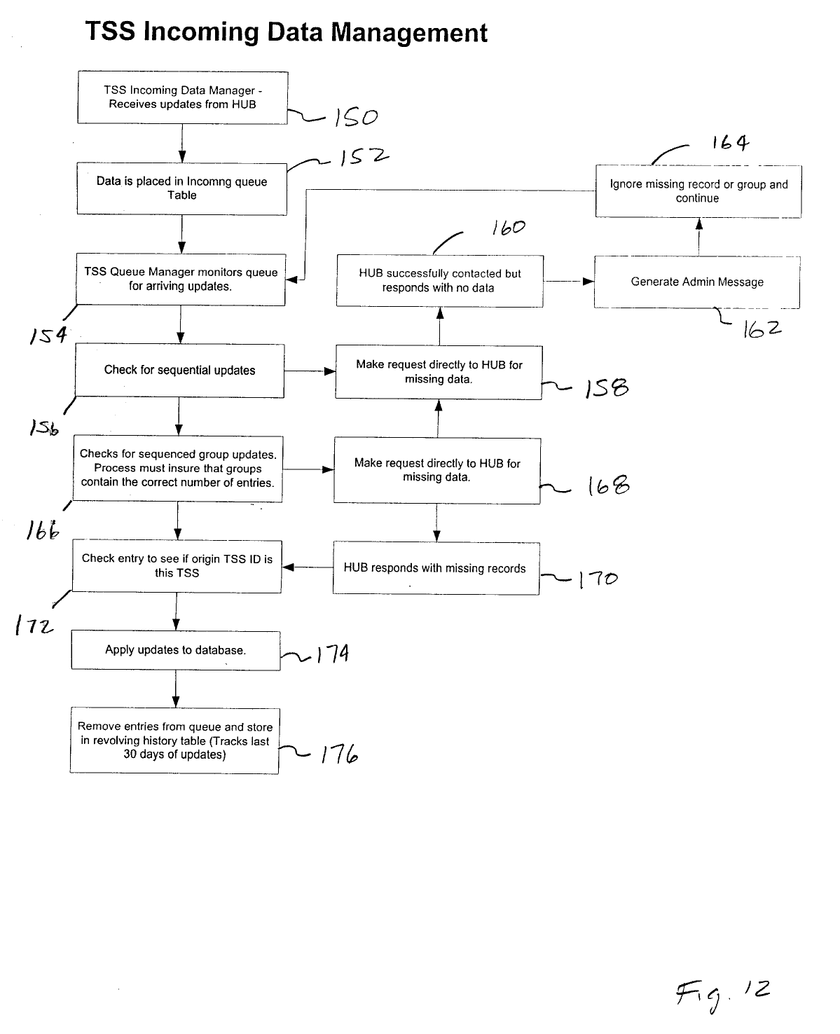

For outgoing data management, as may best be seen in FIG. 11, in a step 130, the hub outgoing data manager monitors an outgoing queue. In the step 132, a log is checked for the last broadcast sequence number. In step 134, a broadcast sequential update and group entries to all TSS systems via packet broadcast across the satellite network takes place and then in a step 136, the update entry is moved to a revolving history table. In addition, in the step 138, the hub listens for direct incoming requests for missing update entries and receives requests from the TSS from the missing entries in a step 140. A lookup update occurs in a step 142 history table if the entry is not found and no response is sent to the TSS in the step 144, if the entry is found, a request is sent back to the TSS in a step 146.

The truck stop server incoming data management is handled, as may best be seen in FIG. 12, in a step 150, an incoming data manager receives updates from the hub server in a step 152, the data is placed in an incoming queue table. In a step 154, the TSS queue manager monitors the queue for arriving updates in a step 156, sequential updates are checked. If the sequential updates check fails, control is transferred to a step 158 causing a request to be made directly to the hub for the missing data. In a step 160, the hub is successfully contacted but responds with no data and generates an administrative message in step 162, causing the missing record or group to be ignored in a step 164, and control to be transferred back to step 154. In a step 166, a check is made for sequence group updates in order to ensure that the groups are complete and contain the correct number of entries. In the event that the check fails, control is transferred to a step 168 which requests data from the hub, and the hub responds in a step 170, with the missing records transferring control to a step 172, wherein entry is checked to see if the origin TSS I.D. is the current TSS. The updates are applied to the database in a step 174, and entries are removed from queue and store in a revolving history table which is not allowed to be older than thirty days in a step 176.

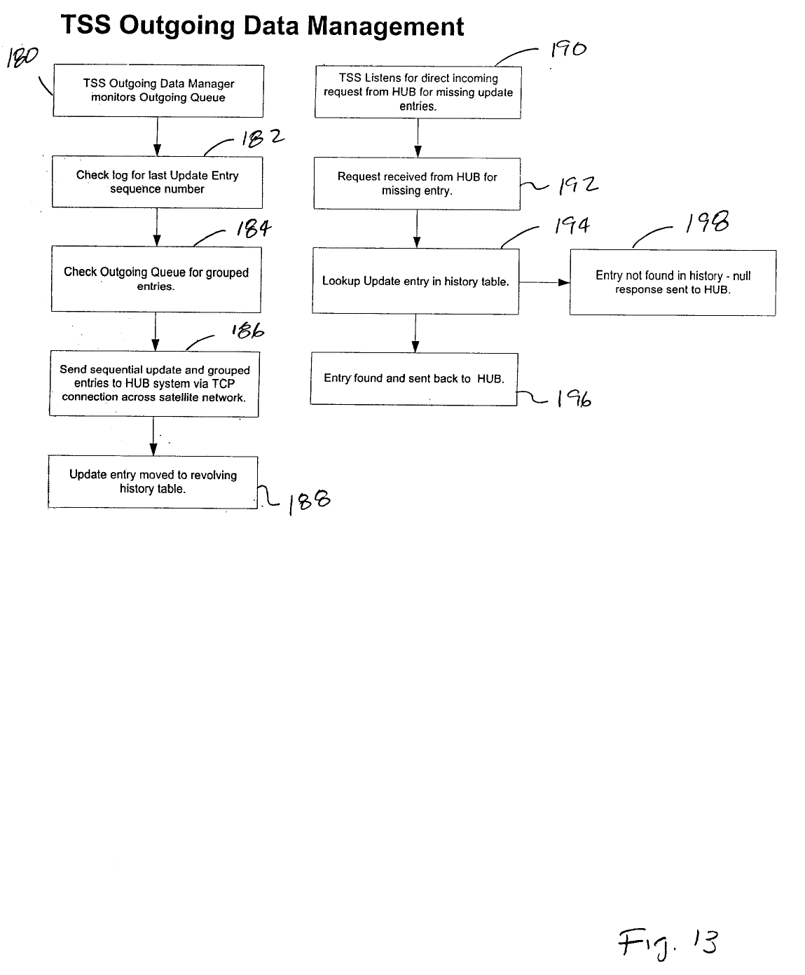

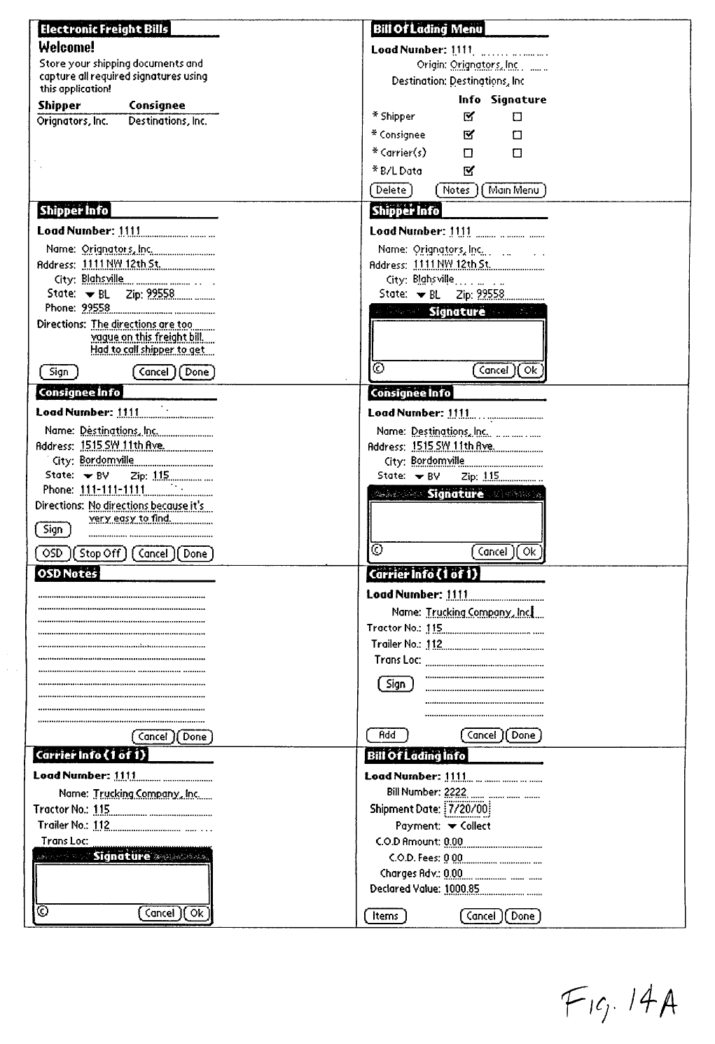

The TSS outgoing data management is handled as may best be seen in FIG. 13, wherein a step 180 the TSS outgoing data manager monitors an outgoing queue. In a step 182, the log is checked for the last update entry sequence number. In a step 184, the outgoing queue is checked for grouped entries. In a step 186, a sequential update and grouped entries are sent to the hub system by a transmission control protocol across the satellite portion of the apparatus 10. In a step 188, the update entry is moved to revolving history table. In addition, the TSS listens for direct incoming requests for hub, for missing update entries in a step 190. If a request is received in a step 192, a step 194 is executed causing a lookup update entry in the history table. If the entry is found in a step 196, the information is sent back to the hub, if the entry is not found, a no response is sent to the hub in a step 198.

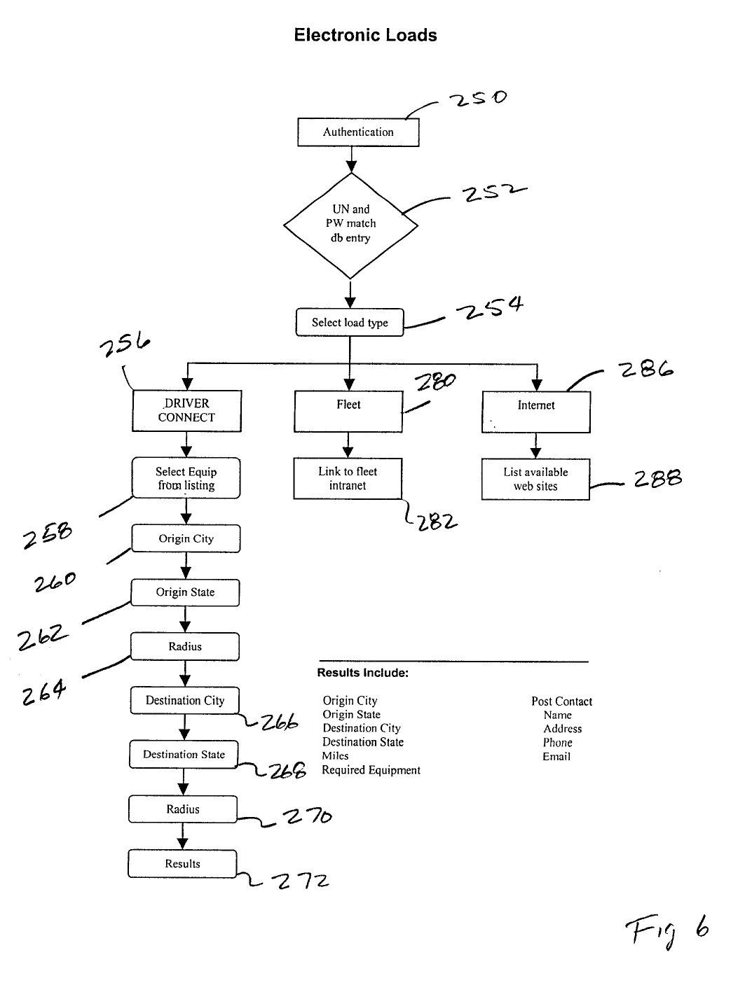

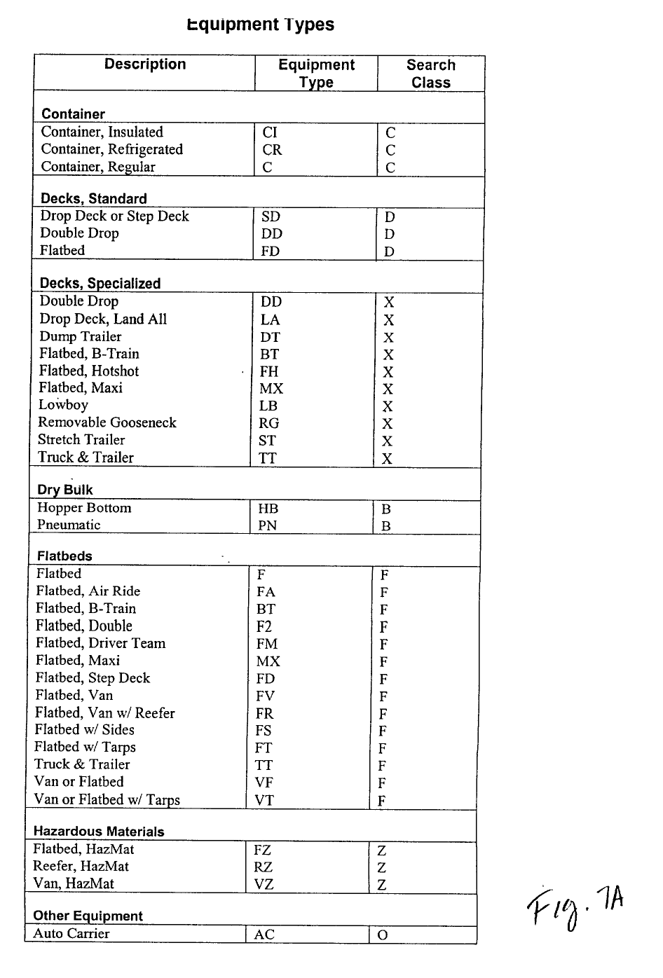

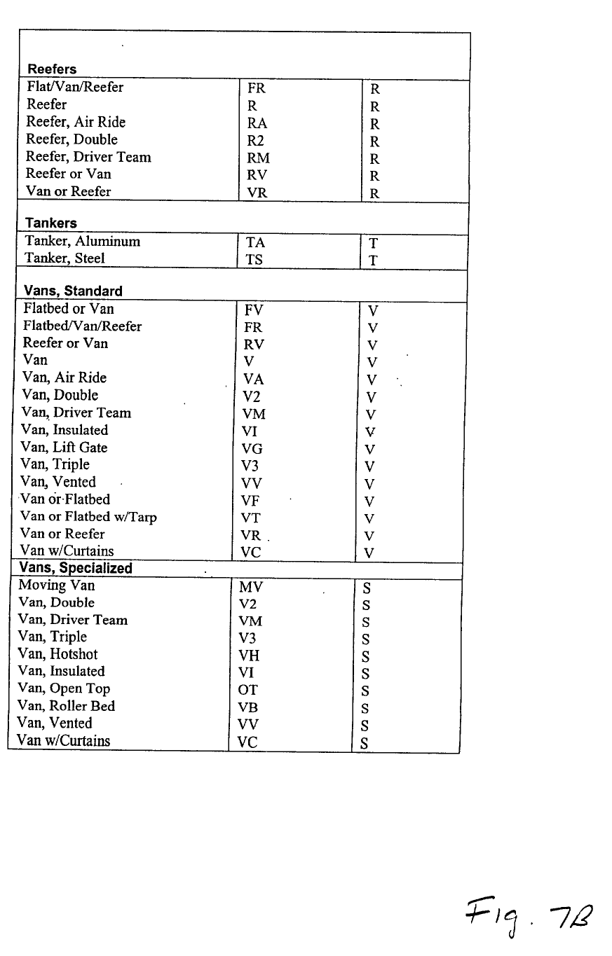

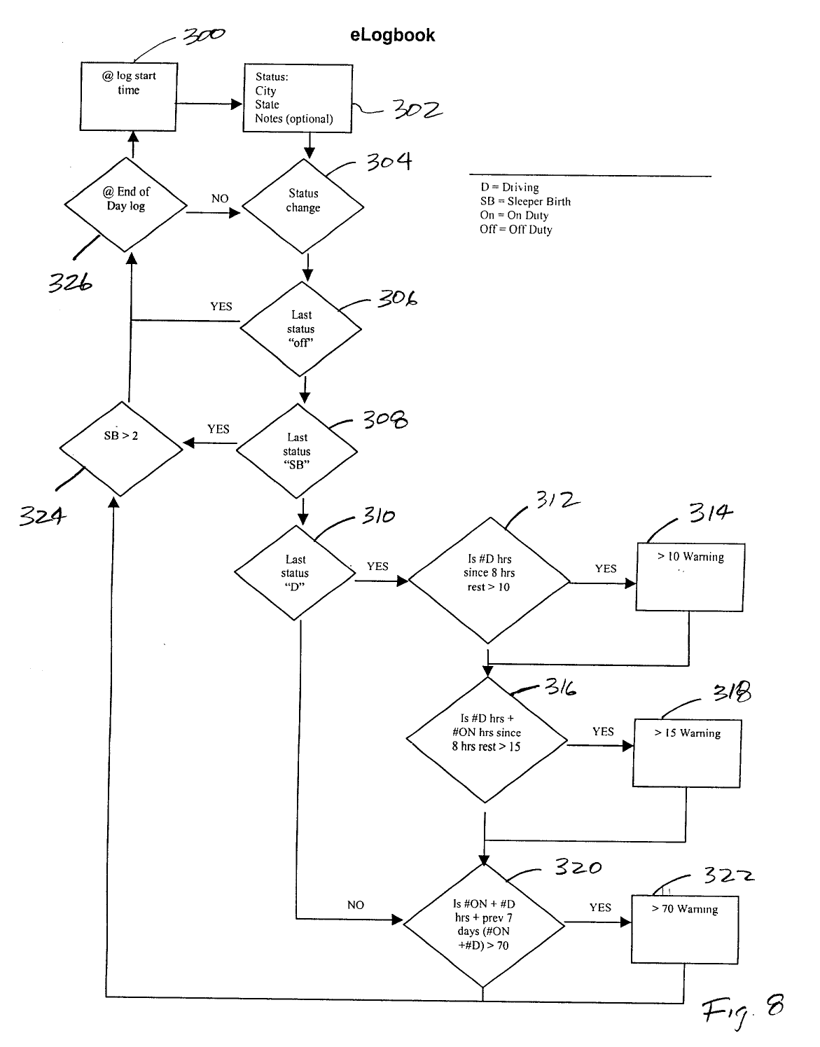

Of the types of information which are sent, the information is packaged as may best be seen in FIG. 6, where the synchronization packet detail is shown with the synchronization packet 200 comprising an SQL payload size field 202, a packet type field 204, a sequence number 206, a group sequence number 208, an origin TSS identifier 210, a time stamp 212, a database name 214, a database user identification 216, a database password 218, and finally the SQL statement itself 220. Thus, it may be appreciated that both group and sequence information as well as time stamping, database naming and database user information and password is transmitted in the synchronization packets. The synchronization packets may be used to send electronic load information as shown in FIG. 6, wherein a step 250, an authentication is done, a match is checked for in a step 252, and a load type is selected in a step 254. Connection may be made to the driver in a step 256 allowing equipment to be selected from a listing in a step 258, the origin city is inserted in step 160, the origin state in a step 262, the distance radius in a step 264, the destination city in a step 266. In addition, the destination state is inserted in a step 268 as well as the radius in a step 270, and the results are compiled in a step 272. In addition, links can be made to a fleet in a step 280, or to a fleet intranet in a step 282 to forward the information, as well as the information being sent over the internet in a step 286 to available websites in a step 288. Equipment type may also be identified as set forth in the tables in FIGS. 7A and FIG. 7B identifying containers, types of decks, bulk shipping, types of flatbeds, whether hazardous material handling equipment is needed, refrigerated equipment, tankers, vans, or specialized vans.

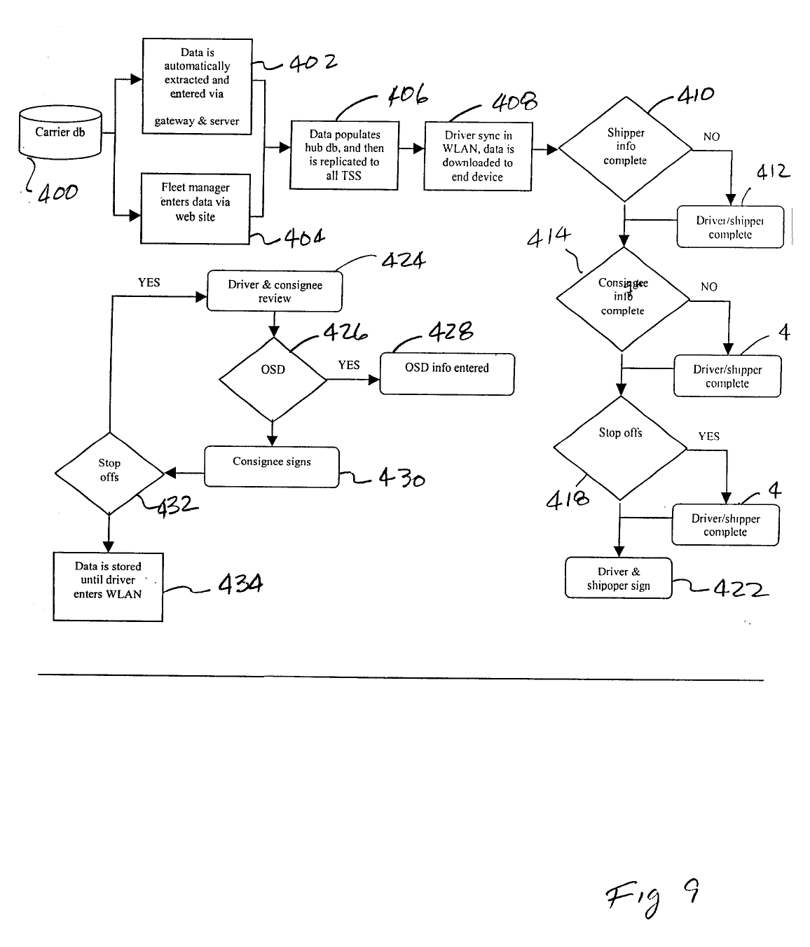

Furthermore, an electronic log book function is provided as set forth in FIG. 8, at a log start time at a step 300, the status, city, states, and notes may be entered in a step 302 for transmission. A test is made for a status change in a step 304, a test is also made for last status off in a step 306 and whether last status is sleeper berth in a step 308. In addition, a test is made to determine whether the last status indicates driving in a step 310, if it is then a step 312 a test is made to determine whether the number of driving hours since 8 hours rest exceeds ten hours. If it is, a warning is issued in a step 314. If it is not, is the driving hours plus the on hours, since eight hours rest greater than sixteen as tested for in a step 316, if it is a greater-than fifteen hour warning is issued in a step 318. Control is then transferred to a step 320, where a determination is made as to whether a seventy hour warning needs to be issued, and if so a seventy hour warning is issued in a step 322. Control is then transferred back to a test step 324 to test for sleeper berth and to an end of the day log in a step 326 which may loop back to log start times, back in 300.

As may best be seen in FIG. 9, the carrier database 400 allows data to be automatically extracted and entered by a gateway end server 402 or allows a fleet manager to enter data via website 404. In step 406, data populates the hub database and is then replicated to all of the truck stop stations via the network. In a step 408, the driver information is synchronized over the wireless local area networks and data is downloaded to the end devices such as the PDAs or the laptop computers. A test is made in the step 410 to determine if the shipper information is complete, if not, control is transferred to a step 412 prompting completion of the driver shipper information. A test is made in a step 414 to determine if the consignee information is complete, if it is not, the driver or shipper completes the information in a step 416. If it is, control is transferred to a stop offs check 418 to determine whether that information has been entered, if it has, the driver and shipper is prompted to complete it in a step 420 and a ship operation signal is given in a step 422.

A driver consignee review may be made in a step 424. OSD information is checked for in a step 426 and if it is not present, the information is entered in a step 428. The consignee can sign off in a step 430 after which the stop officer identified in a step 432, and the data is stored until the driver enters the wireless local area network in a step 434 where it can be downloaded.

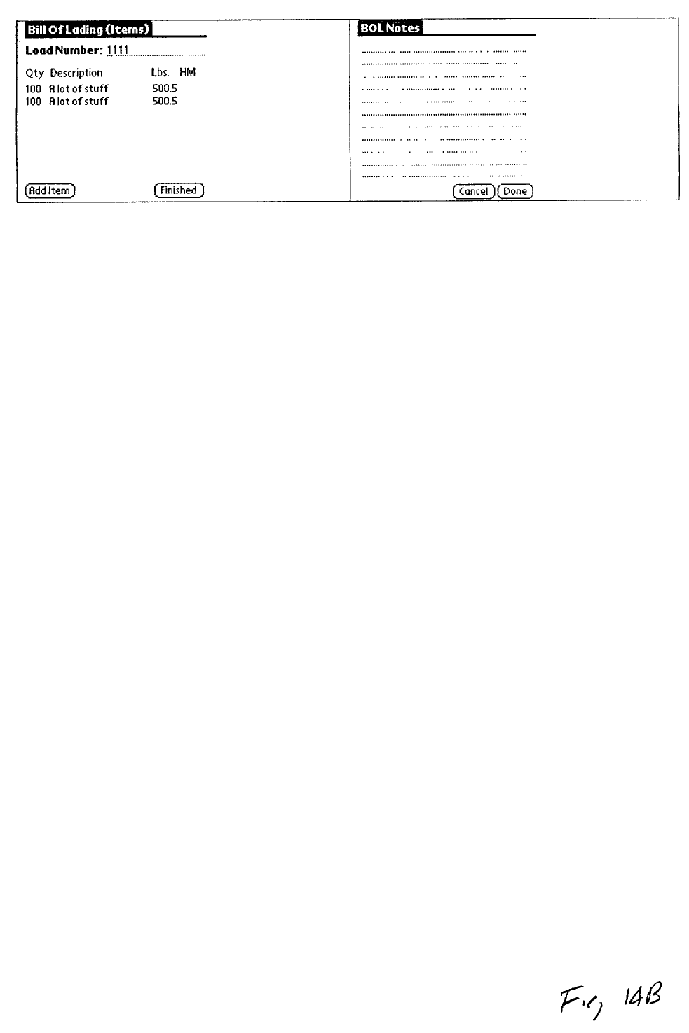

Among the data which can be sent, it may best be seen in FIG. 14A are electronic freight bills which include the originators name, address, city, phone number and directions, as well as consignee information including the destination name, address, city, telephone number, zip code and directions to the consignee. Carrier information may be provided, such as the trucking company, the tractor number, the trailer number, as well as a bill of lading menu to indicate whether signatures are required, identify the load number. The bill of lading will also identify the quantity, the description of the material and the weight.

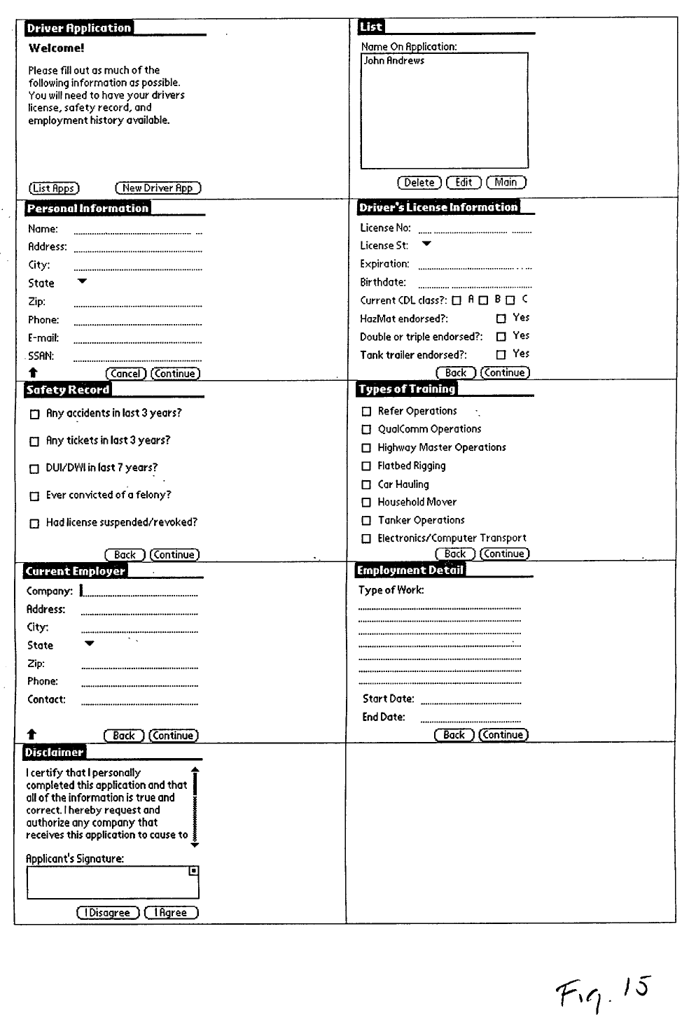

In addition, information can be sent over the network related to a driver application, employment application form is shown in FIG. 15, which may be completed over a PDA. As shown, the PDA includes personal information, safety record, current employer, screens drivers license information prompts, types of training prompts and employment detail, even asking for specific information such as histories of accidents, citations received, driving under the influence offenses and license suspensions and revocations. Finally, the PDA provides a place for the applicant signature to be inserted and digitized and forwarded to the hub.

While there have been illustrated and described particular embodiments of the present invention, it will be appreciated that numerous changes and modifications will occur to those skilled in the art, and it is intended in the appended claims to cover all those changes and modifications which fall within the true spirit and scope of the present invention.

What is claimed is:

1. Apparatus for providing information over a wireless communication network, comprising:
a hub server for storing a relational database of information;
a satellite link system connected to the hub server for receiving information and sending
a plurality of node servers in communication with the satellite for receiving and information; and
a wireless local area network connected to the node server for providing spread spectrum communication with one or more hand-held computing devices for receiving information sending information.

2. A method of handling information, comprising:
generating a relational database at a hub server containing information;
transmitting at least a portion of the information from the hub server to a communication satellite;
the communication satellite sending the information to one or more local satellite receivers;
transmitting the information from the local satellite receiver to a node server; and
transmitting at least a portion of the information to a hand-held computation device via spread spectrum transmission.
